(19) United States
(12) Patent Application Publication
(10) Pub. No.: US 2010/0066742 A1
(43) Pub. Date: Mar. 18, 2010

(54) STYLIZED PROSODY FOR SPEECH SYNTHESIS-BASED APPLICATIONS

(75) Inventors: Yao Qian, Beijing (CN); Frank Kao-ping Soong, Beijing (CN)

Correspondence Address: MICROSOFT CORPORATION, ONE MICROSOFT WAY, REDMOND, WA, 98052, US

(73) Assignee: MICROSOFT CORPORATION, Redmond, WA (US)

(21) Appl. No.: 12/212,651

(22) Filed: Sep. 18, 2008

(51) Int. Cl. G09G 5/22; G10L 19/14

(52) U.S. Cl. 345/440.1; 704/205; 704/E19.001

(57) ABSTRACT

Described is a technology by which the prosody of synthesized speech may be changed by varying data associated with that speech. An interface displays a visual representation of synthesized speech as one or more waveforms, along with the corresponding text from which the speech was synthesized. The user may interact with the visual representation to change data corresponding to the prosody, e.g., to change duration, pitch and/or loudness data, with respect to a part (or all) of the speech. The part of the speech that may be varied may comprise a phoneme, a morpheme, a syllable, a word, a phrase, and/or a sentence. The changed speech can be played back to hear the change in prosody resulting from the interactive changes. The user can also change the text and hear/see newly synthesized speech, which may then be similarly edited to change data that corresponds to that speech's prosody.

### BACKGROUND

The use of speech synthesis-based applications is becoming more and more prevalent. Such applications are used for handling information inquiries, by reservation and ordering systems, to perform email reading, and so forth. The generated speech used in such applications ordinarily comes from a pre-trained model, or pre-recordings. As a result, it is difficult to change the prosody of synthesized speech to meet a user's desired style.

However, in some applications, it is more powerful if the speech is synthesized according to user's specific requirements. For example, computer-Assisted Language Learning (CALL) systems output speech based on a user's own voice characteristics; consider using such a system to learn a language like Mandarin Chinese, where prosody-like tonality is essential to lexical access and for disambiguation of homonyms. Prosody is thus important for the user to understand and to match when speaking. Other uses, such as post-editing synthesized speech to make it sound more natural, may likewise benefit from changed prosody.

### SUMMARY

This Summary is provided to introduce a selection of representative concepts in a simplified form that are further described below in the Detailed Description. This Summary is not intended to identify key features or essential features of the claimed subject matter, nor is it intended to be used in any way that would limit the scope of the claimed subject matter.

Briefly, various aspects of the subject matter described herein are directed towards a technology by which the prosody of speech may be changed by varying data associated with that speech. An interface or the like displays a visual representation of speech such as in the form of one or more waveforms and corresponding text. The interface allows changing prosody of the speech based on interaction with the visual representation to change data corresponding to the prosody, e.g., duration, pitch and/or loudness data, with respect to at least one part of the speech. The part of the speech that may be varied may comprise a phoneme, a morpheme, a syllable, a word, a phrase, and/or a sentence.

In one implementation, the changed speech can be played back to hear the change in prosody resulting from the interactive changes. The user can also change the text and hear newly synthesized speech, which may then be similarly edited to change data that corresponds to the prosody.

Other advantages may become apparent from the following detailed description when taken in conjunction with the drawings.

### BRIEF DESCRIPTION OF THE DRAWINGS

The present invention is illustrated by way of example and not limited in the accompanying figures in which like reference numerals indicate similar elements and in which:

FIG. 1 is a block diagram showing an example source-filter model for a speech production process, and an example interface for interacting with speech output to change prosody.

FIG. 2 a block diagram showing example components for Hidden Markov Model (HMM)-based speech synthesis.

FIG. 3 is a representation of a graphical interface for interacting with speech output to change prosody.

FIG. 4 is a flow diagram showing example steps that may be taken to handle interaction for changing prosody, including for changing duration, pitch and loudness.

FIG. 5 shows an illustrative example of a computing environment into which various aspects of the present invention may be incorporated.

### DETAILED DESCRIPTION

Various aspects of the technology described herein are generally directed towards controlling prosody, particularly for speech synthesized (e.g., text-to-speech) applications. In one aspect, there is provided a visual interface that shows a visual representation of speech, and includes an interactive mechanism for changing the pitch, duration and/or loudness of synthesized speech, e.g., in the framework of HMM-based speech synthesis. A set of speech may be interacted with as a whole (e.g., an entire sentence or paragraph), or smaller portions thereof, e.g., a phoneme, morpheme, syllable, word or phrase.

While some of the examples described herein are directed towards text-to-speech applications, such as related to speech synthesis and supervised machine learning, e.g., to supervise a speech synthesis system to generate specific prosody as desired by a user, e.g., with emotions, intonations and speaking styles, speech or tones rather than text may be directly input. For example, in computer-assisted language learning, a user may speak and view generated prosody with a user's own voice characteristics; singing voice synthesis can generate a singing voice by using (text or actual) speech data according to a given melody. Further, the technology has application in the study of speech perception, e.g., via perception tests for the research of phonetics and phonology in linguistics and cognitive psychology and perception in psychology, e.g., to examine the discriminative prosody area for the disambiguation of homonyms.

As such, the present invention is not limited to any particular embodiments, aspects, concepts, structures, functionalities or examples described herein. Rather, any of the embodiments, aspects, concepts, structures, functionalities or examples described herein are non-limiting, and the present invention may be used various ways that provide benefits and advantages in speech and/or sound processing in general.

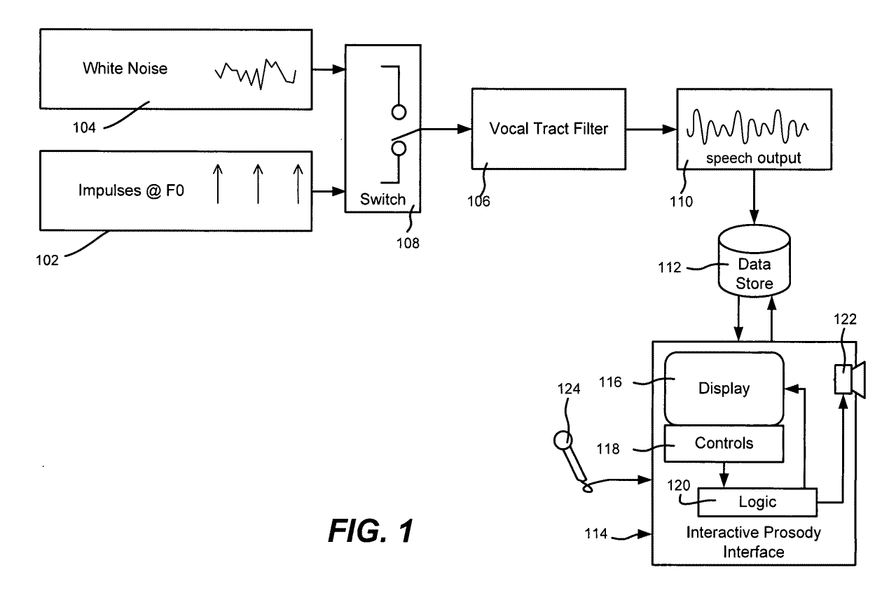

Turning to FIG. 1, in one example, a speech production mechanism/process may be represented by a source-filter model as generally represented in FIG. 1. In this example model, excitation input controls whether a sound is voiced; for example vowels corresponds to voiced, (periodic impulse train input 102), while fricatives (white noise 104 like “fff” or “sss” sounds) correspond to unvoiced. The sound produced is controlled by the shape of the filter or vocal tract 106. A switch 108 or the like, controlled in patterns according to training, for example, combines the impulses with the white noise by switching at appropriate times to provide input to the vocal tract filter 106 from which speech output 110 is generated.

As described below, the speech output 110 may be stored, whether in memory or a data store 112 (as exemplified in FIG. 1), for processing via an interactive prosody interface 114. In one implementation, the interface 114 outputs visual data representing some amount of speech to a display 116, and provides controls 118 for interacting with the displayed representation via logic 120, such as to selectively change pitch, duration and/or loudness of any selected portion of the speech. The interface also controls output to a speaker 122, e.g., for replaying the initial speech and/or the modified prosody speech following any changes made to the pitch, duration and/or loudness of the speech. A microphone 124 or other sound source such as to input speech (e.g., for computer-assisted learning) and/or musical tones may also be provided depending on the application.

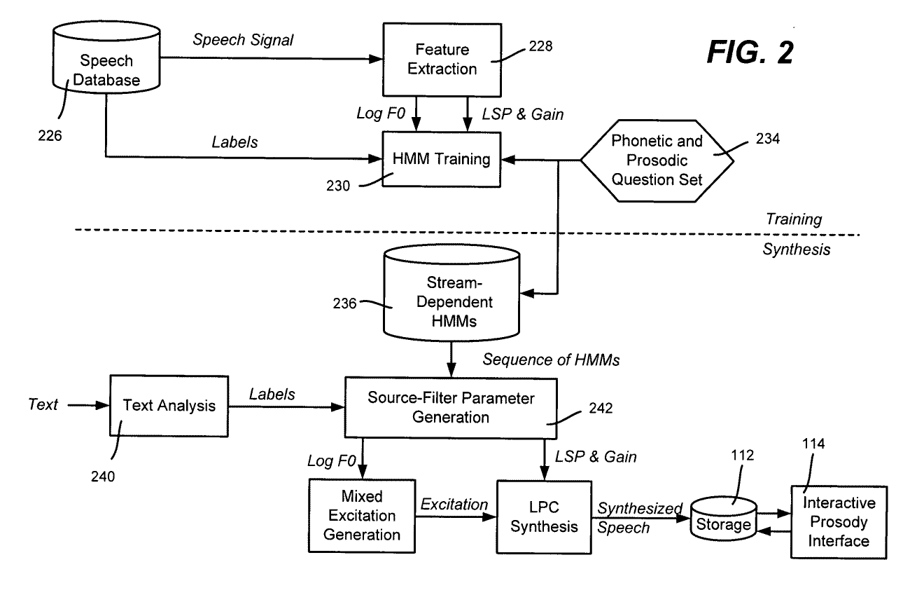

FIG. 2 provides a more detailed model for using the source-filter model in speech synthesis in one example implementation. Vocal cord (source) and vocal tract (filter) features may be modeled separately in HMM-based speech synthesis. Therefore, it is flexible to change pitch (the period of the impulse train) independently. Note that FIG. 2 shows an HMM-based speech synthesis system having both training and synthesis phases represented in the same diagram, although as can be readily appreciated, training and synthesis may be performed separately.

In the training phase, a speech signal (e.g., from a database 226) is converted to a sequence of observed feature vectors through a feature extraction module 228, and modeled by a corresponding sequence of HMMs. Each observed feature vector consists of spectral parameters and excitation parameters, which are separated into different streams. The spectral feature comprises line spectrum pair (LSP) and log gain, and the excitation feature is the log of the fundamental frequency (F0). LSPs are modeled by continuous HMMs and F0s are modeled by multi-space probability distribution HMM (MSD-HMM), which provides a modeling of F0 without any heuristic assumptions or interpolations. Context-dependent phone models are used to capture the phonetic and prosody co-articulation phenomena. State typing based on decision-tree and minimum description length (MDL) criterion is applied to overcome the problem of data sparseness in training. An HMM training mechanism 230 inputs the log F0, LSP and Gain, and decision data 234 to output stream-dependent models 236, which are built to cluster the spectral, prosodic and duration features into separated decision trees.

In the synthesis phase, input text is converted first into a sequence of contextual labels through a text analysis component 240. The corresponding contextual HMMs are retrieved by traversing the decision trees (corresponding to the models 236) and the duration of each state is obtained from a duration model. The LSP, gain and F0 trajectories are generated by using a parameter generation algorithm 242 based on maximum likelihood criterion with dynamic feature and global variance constraints. A speech waveform is synthesized from the generated spectral and excitation parameters by LPC synthesis as generally known and referred to above. This waveform may be used, or stored for prosody manipulation as described herein, e.g., in some memory or storage (e.g., corresponding to the data store 112 of FIG. 1) via the interactive interface 114.

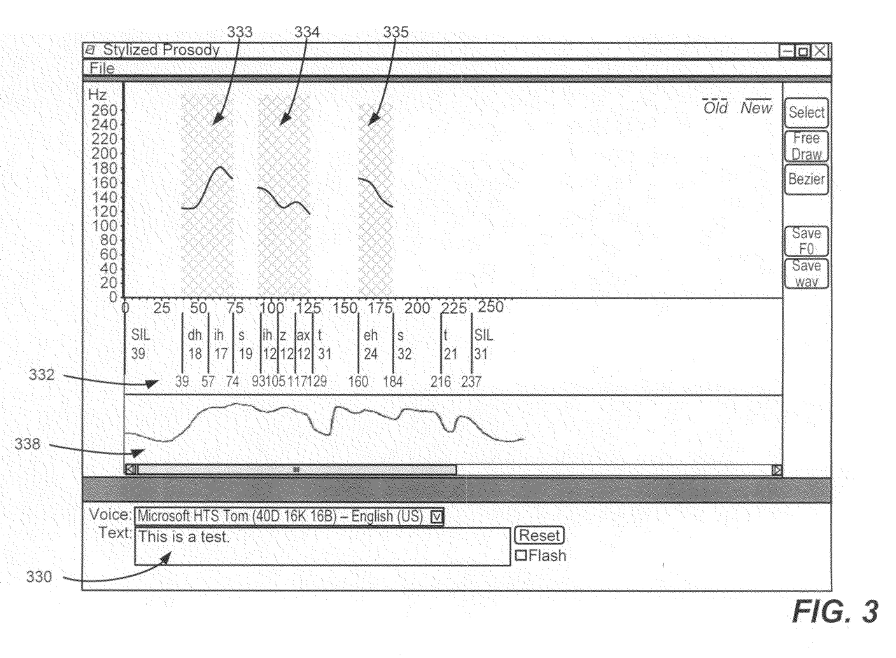

FIG. 3 shows an interface by which the pitch, duration and loudness of synthesized speech under the framework of HMM-based speech synthesis may be flexibly changed as desired by a user. In one implementation, the display 116 (FIG. 1) is touch-sensitive, whereby the controls 118 correspond to user interaction with the display. However as can be readily appreciated, any type (or combination of types) of human input device is feasible, e.g., via a pointing device, keyboard, speech and so forth.

In FIG. 3, the speech waveform is graphically displayed with frequency (hertz) on the y-axis and time (in any suitable unit) on the x-axis. The user has typed in or otherwise input “This is a test.” in the text input box 330 which has been recognized as speech. The section labeled 332 shows the parts of the speech waveform delineated by duration (with “SIL” representing silence), e.g., the “t” sound in the word “test” occurs for 31 units, followed by the “eh” sound in the word “test” for 24 units, and so on. The numbers (e.g., 39, 57, 74 and so forth) below the bars separating each part of speech show the corresponding time unit of each bar.

With respect to duration, a user is able to change the duration of phoneme, morpheme, syllable, word, phrase and sentence. For model generated speech, an adjustment factor ρ is first calculated by:

$$ρ = ( T - {\sum }_{k = 1}^{K} u ( k ) ) / {\sum }_{k = 1}^{K} {σ}^{2} ( k )$$

where u(k) and σ²(k) are the mean and variance of the duration density of state k, respectively. T is the duration as modifiable by the user, and may be at any levels of phoneme, morpheme, syllable, word, phrase and sentence. Each state duration d(k) may be adjusted according to ρ as:

d(k)=u(k)+ρ*σ²(k)

For online recorded speech, the state duration is first obtained by forced alignment, with that duration linearly shrunk and/or expanded according to the user's input.

By way of example, a user may change the duration by dragging one of the bars in the area 332 to increase or decrease the duration value of its corresponding part of speech. To vary a full word at the same time, for example, a user may select some or all of the text in the box 332, and drag the last bar of that word, for example, proportionally increasing or decreasing the durations of each of the parts of that word. A syllable may be modified by selecting part of a word, and so forth. The duration of the entire sentence may be increased.

To adjust pitch, the F0 trajectories are modifiable according to the user's input in the generation part of HMM-based speech synthesis. The user's input may comprise the local contour for a voiced region or global schematic curve for intonation. For a local contour, the value of F0 is directly modifiable. For a global schematic curve, the tendency of F0 trajectory is made as approximate as possible with minimum changing local fine structure of F0 contour.

By way of example, a user may change the pitch (of impulses) by interactively varying the waveforms shown in the displayed areas 333-345. The user may move each of the waveforms up and down as a whole, or all of the waveforms together, or a portion of one, e.g., by highlighting or pointing to that portion to move.

Loudness is adjustable by directly modifying the gain trajectories according to the user's input in the generation part of HMM-based speech synthesis. To vary the loudness, a user may interact in the area 338, for example.

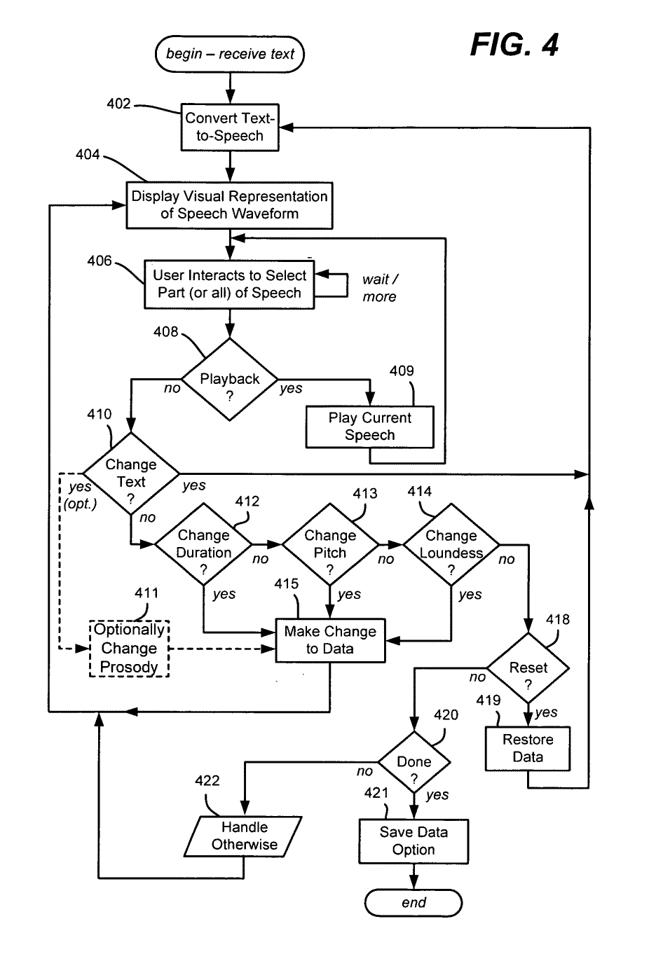

FIG. 4 shows example steps that may be taken to provide logic for one such interface. Step 402 represents converting text-to-speech, although as can be readily appreciated, speech may be directly input (and converted to text for interaction purposes). Step 404 shows the waveform being displayed, such as on the user interface of FIG. 3, to facilitate interaction therewith.

Step 406 represents some user interaction taking place, such as to request speech playback, select some of the text, type in or otherwise edit/enter different text, move a duration bar, change the pitch, adjust the loudness, and so forth. If the interaction is such that an action needs to be taken, step 406 continues to step 408. (Note for example that simply selecting text is not shown herein as being such an action, and is represented by the wait/more loop at the right side of step 406.)

Steps 408 and later represent command processing. As can be readily appreciated, these steps need not be in any particular order, and indeed may be event driven rather than part of a loop as shown herein for purposes of simplicity.

Steps 408 and 409 handle the user requesting audio playback of whatever state the current speech is in, whether initially or after any prosody modifications. Note that the playback may be automatic (or user-configurable as to whether it is automatic) whenever the user makes a change to the prosody. For example, a user may make a change, and if the user stops interacting for a short time or moves to a different interaction area, automatically hear the changed speech played back.

Step 410 represents detecting a change to the text. If this occurs, the process returns to step 402 to convert the new text to speech via synthesis. As can be readily appreciated, new or changed speech may be similarly input, with text recognized from the speech.

Moreover, via step 411, the prosody may be automatically changed when appropriate to make a change to text sound more natural in the synthesized speech. For example, in the English language, changing a statement to a question, such as “This is a test.” to “This is a test?” results in a pitch increase on the last word, (and vice-versa). A relative pitch change may be automatically made upon detection of such a text change. Changing to an exclamation point may increase pitch and/or loudness, and/or shorten duration, relative to an original statement or question, for at least part of the sentence. Step 411 is shown as dashed to indicate that such a step is optional (and may branch to step 415, described below), and alternatively may be performed in the conversion step of step 402.

Steps 412-414 represent the user making prosody changes, to duration, pitch or loudness, respectively as described above. The change varies the prosody data (step 405) corresponding to the frequency waveforms or loudness waveform, which is redrawn as represented by step 404. Other steps such as reset to restore the initial data (step 418 and 419), and done (steps 420 and 421, including an option to save changes) are shown. Step 422 represents other action handling, such as to change input modes, for example.

### Exemplary Operating Environment

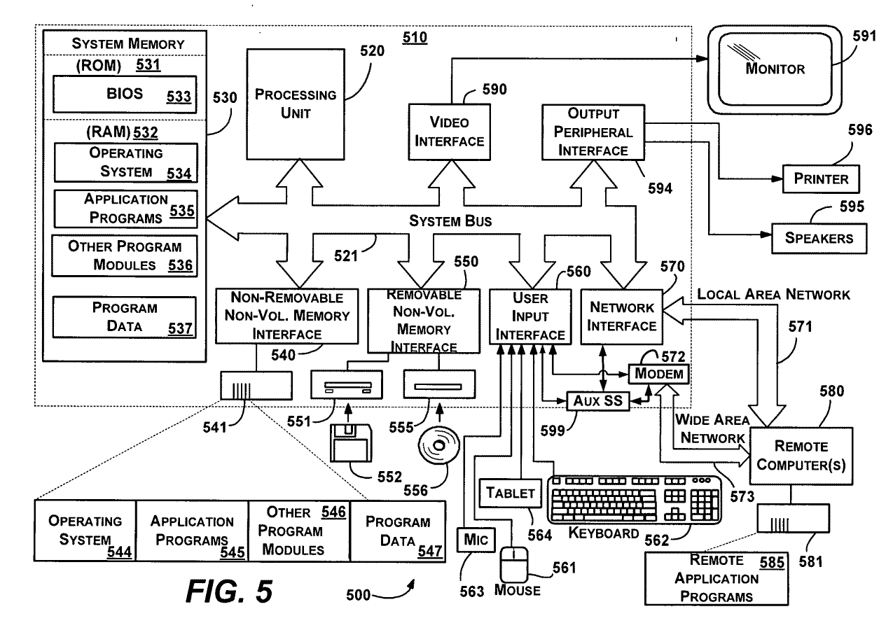

FIG. 5 illustrates an example of a suitable computing and networking environment 500 on which the examples of FIGS. 1-4 may be implemented. The computing system environment 500 is only one example of a suitable computing environment and is not intended to suggest any limitation as to the scope of use or functionality of the invention. Neither should the computing environment 500 be interpreted as having any dependency or requirement relating to any one or combination of components illustrated in the exemplary operating environment 500.

The invention is operational with numerous other general purpose or special purpose computing system environments or configurations. Examples of well known computing systems, environments, and/or configurations that may be suitable for use with the invention include, but are not limited to: personal computers, server computers, hand-held or laptop devices, tablet devices, multiprocessor systems, microprocessor-based systems, set top boxes, programmable consumer electronics, network PCs, minicomputers, mainframe computers, distributed computing environments that include any of the above systems or devices, and the like.

The invention may be described in the general context of computer-executable instructions, such as program modules, being executed by a computer. Generally, program modules include routines, programs, objects, components, data structures, and so forth, which perform particular tasks or implement particular abstract data types. The invention may also be practiced in distributed computing environments where tasks are performed by remote processing devices that are linked through a communications network. In a distributed computing environment, program modules may be located in local and/or remote computer storage media including memory storage devices.

With reference to FIG. 5, an exemplary system for implementing various aspects of the invention may include a general purpose computing device in the form of a computer 510. Components of the computer 510 may include, but are not limited to, a processing unit 520, a system memory 530, and a system bus 521 that couples various system components including the system memory to the processing unit 520. The system bus 521 may be any of several types of bus structures including a memory bus or memory controller, a peripheral bus, and a local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus also known as Mezzanine bus.

The computer 510 typically includes a variety of computer-readable media. Computer-readable media can be any available media that can be accessed by the computer 510 and includes both volatile and nonvolatile media, and removable and non-removable media. By way of example, and not limitation, computer-readable media may comprise computer storage media and communication media. Computer storage media includes volatile and nonvolatile, removable and non-removable media implemented in any method or technology for storage of information such as computer-readable instructions, data structures, program modules or other data. Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can accessed by the computer 510.

Communication media typically embodies computer-readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of the any of the above may also be included within the scope of computer-readable media.

The system memory 530 includes computer storage media in the form of volatile and/or nonvolatile memory such as read only memory (ROM) 531 and random access memory (RAM) 532. A basic input/output system 533 (BIOS), containing the basic routines that help to transfer information between elements within computer 510, such as during start-up, is typically stored in ROM 531. RAM 532 typically contains data and/or program modules that are immediately accessible to and/or presently being operated on by processing unit 520. By way of example, and not limitation, FIG. 5 illustrates operating system 534, application programs 535, other program modules 536 and program data 537.

The computer 510 may also include other removable/non-removable, volatile/nonvolatile computer storage media. By way of example only, FIG. 5 illustrates a hard disk drive 541 that reads from or writes to non-removable, nonvolatile magnetic media, a magnetic disk drive 551 that reads from or writes to a removable, nonvolatile magnetic disk 552, and an optical disk drive 555 that reads from or writes to a removable, nonvolatile optical disk 556 such as a CD ROM or other optical media. Other removable/non-removable, volatile/nonvolatile computer storage media that can be used in the exemplary operating environment include, but are not limited to, magnetic tape cassettes, flash memory cards, digital versatile disks, digital video tape, solid state RAM, solid state ROM, and the like. The hard disk drive 541 is typically connected to the system bus 521 through a non-removable memory interface such as interface 540, and magnetic disk drive 551 and optical disk drive 555 are typically connected to the system bus 521 by a removable memory interface, such as interface 550.

The drives and their associated computer storage media, described above and illustrated in FIG. 5, provide storage of computer-readable instructions, data structures, program modules and other data for the computer 510. In FIG. 5, for example, hard disk drive 541 is illustrated as storing operating system 544, application programs 545, other program modules 546 and program data 547. Note that these components can either be the same as or different from operating system 534, application programs 535, other program modules 536, and program data 537. Operating system 544, application programs 545, other program modules 546, and program data 547 are given different numbers herein to illustrate that, at a minimum, they are different copies. A user may enter commands and information into the computer 510 through input devices such as a tablet, or electronic digitizer, 564, a microphone 563, a keyboard 562 and pointing device 561, commonly referred to as mouse, trackball or touch pad. Other input devices not shown in FIG. 5 may include a joystick, game pad, satellite dish, scanner, or the like. These and other input devices are often connected to the processing unit 520 through a user input interface 560 that is coupled to the system bus, but may be connected by other interface and bus structures, such as a parallel port, game port or a universal serial bus (USB). A monitor 591 or other type of display device is also connected to the system bus 521 via an interface, such as a video interface 590. The monitor 591 may also be integrated with a touch-screen panel or the like. Note that the monitor and/or touch screen panel can be physically coupled to a housing in which the computing device 510 is incorporated, such as in a tablet-type personal computer. In addition, computers such as the computing device 510 may also include other peripheral output devices such as speakers 595 and printer 596, which may be connected through an output peripheral interface 594 or the like.

The computer 510 may operate in a networked environment using logical connections to one or more remote computers, such as a remote computer 580. The remote computer 580 may be a personal computer, a server, a router, a network PC, a peer device or other common network node, and typically includes many or all of the elements described above relative to the computer 510, although only a memory storage device 581 has been illustrated in FIG. 5. The logical connections depicted in FIG. 5 include one or more local area networks (LAN) 571 and one or more wide area networks (WAN) 573, but may also include other networks. Such networking environments are commonplace in offices, enterprise-wide computer networks, intranets and the Internet.

When used in a LAN networking environment, the computer 510 is connected to the LAN 571 through a network interface or adapter 570. When used in a WAN networking environment, the computer 510 typically includes a modem 572 or other means for establishing communications over the WAN 573, such as the Internet. The modem 572, which may be internal or external, may be connected to the system bus 521 via the user input interface 560 or other appropriate mechanism. A wireless networking component 574 such as comprising an interface and antenna may be coupled through a suitable device such as an access point or peer computer to a WAN or LAN. In a networked environment, program modules depicted relative to the computer 510, or portions thereof, may be stored in the remote memory storage device. By way of example, and not limitation, FIG. 5 illustrates remote application programs 585 as residing on memory device 581. It may be appreciated that the network connections shown are exemplary and other means of establishing a communications link between the computers may be used.

An auxiliary subsystem 599 (e.g., for auxiliary display of content) may be connected via the user interface 560 to allow data such as program content, system status and event notifications to be provided to the user, even if the main portions of the computer system are in a low power state. The auxiliary subsystem 599 may be connected to the modem 572 and/or network interface 570 to allow communication between these systems while the main processing unit 520 is in a low power state.

### Conclusion

While the invention is susceptible to various modifications and alternative constructions, certain illustrated embodiments thereof are shown in the drawings and have been described above in detail. It should be understood, however, that there is no intention to limit the invention to the specific forms disclosed, but on the contrary, the intention is to cover all modifications, alternative constructions, and equivalents falling within the spirit and scope of the invention.

What is claimed is:

1. In a computing environment, a method comprising, outputting a visual representation including a set of one or more waveforms and corresponding text, and changing prosody of the speech based on interaction with the visual representation to change data corresponding to the prosody.

2. The method of claim 1 wherein changing the prosody of the speech comprises changing the data corresponding to a phoneme, a morpheme, a syllable, a word, a phrase, or a sentence, or any combination of a phoneme, a morpheme, a syllable, a word, a phrase, or a sentence.

3. The method of claim 1 wherein changing the prosody of the speech comprises changing the data corresponding to duration, pitch or loudness, or any combination of duration, pitch or loudness, with respect to at least one part of the speech.

4. The method of claim 2 wherein changing the prosody of the speech comprises changing the data corresponding to the duration, pitch or loudness, or any combination of duration, pitch or loudness, of a phoneme, a morpheme, a syllable, a word, a phrase, or a sentence, or any combination of a phoneme, a morpheme, a syllable, a word, a phrase, or a sentence.

5. The method of claim 1 further comprising, playing back at least part of the speech after changing the data corresponding to the prosody.

6. The method of claim 1 further comprising, receiving the text, and generating speech from the text.

7. The method of claim 6 further comprising, receiving changed text, and generating new speech from the changed text.

8. The method of claim 6 further comprising, receiving changed text, and automatically changing the prosody in response to receiving the changed text.

9. In a computing environment, a system comprising, a speech synthesis mechanism that outputs speech from text, and an interface coupled to the speech synthesis mechanism, the interface configured to output a visual representation including a set of one or more waveforms and corresponding text, and to receive input, including input that changes data corresponding to prosody of the speech.

10. The system of claim 9 wherein the speech synthesis mechanism is based upon a Hidden Markov Model system.

11. The system of claim 9 wherein the data corresponding to prosody of the speech comprises duration-related data, pitch-related data or loudness related data, or any combination of duration-related data, pitch-related data or loudness related data, and wherein the interface provides interaction to change the prosody of a phoneme, a morpheme, a syllable, a word, a phrase, or a sentence, or any combination of a phoneme, a morpheme, a syllable, a word, a phrase, or a sentence.

12. The system of claim 9 wherein the data corresponding to prosody of the speech comprises duration-related data, wherein the interface displays the duration-related data corresponding to parts of the speech, and wherein the interface allows interaction with the duration-related data to independently vary the duration of at least one part of the speech to change the prosody.

13. The system of claim 9 wherein the data corresponding to prosody of the speech comprises pitch-related data, wherein the interface displays the pitch-related data corresponding to parts of the speech, and wherein the interface allows interaction with the pitch-related data to independently vary the pitch of at least one part of the speech to change the prosody.

14. The system of claim 9 wherein the data corresponding to prosody of the speech comprises loudness-related data, wherein the interface displays the loudness-related data corresponding to parts of the speech, and wherein the interface allows interaction with the loudness-related data to independently vary the loudness of separate parts of the speech to change the prosody.

15. The system of claim 9 wherein the interface displays loudness-related data corresponding to a set of speech, and wherein the interface allows interaction with the loudness-related data to vary the loudness of the corresponding speech.

16. The system of claim 9 wherein the interface provides interaction to change the prosody of a phoneme, a morpheme, a syllable, a word, a phrase, or a sentence, or any combination of a phoneme, a morpheme, a syllable, a word, a phrase, or a sentence.

17. One or more computer-readable media having computer-executable instructions, which when executed perform steps, comprising:
outputting a visible representation of speech and corresponding text;
receiving user interaction corresponding to at least part of the speech; and
changing data corresponding to prosody associated with the speech based on the user interaction.

18. The one or more computer-readable media of claim 17 wherein changing the data corresponding to prosody associated with the speech comprises changing duration, pitch or loudness, or any combination of duration, pitch or loudness, with respect to at least one part of the speech.

19. The one or more computer-readable media of claim 17 wherein changing the data corresponding to prosody associated with the speech comprises changing data corresponding to a phoneme, a morpheme, a syllable, a word, a phrase, or a sentence, or any combination of a phoneme, a morpheme, a syllable, a word, a phrase, or a sentence.

20. The one or more computer-readable media of claim 17 having further computer-executable instructions comprising, playing back changed speech corresponding to the speech after changing the data.
